(19) United States
(12) Patent Application Publication
(10) Pub. No.: US 2007/0137453 A1
(43) Pub. Date: Jun. 21, 2007

(54) Cutting tool for cutting a sheet

(75) Inventor: Lionel Marcon, Montmorency (FR)

Correspondence Address: LEYDIG VOIT & MAYER, LTD, 700 THIRTEENTH ST. NW, SUITE 300, WASHINGTON, DC, 20005-3960, US

(73) Assignee: Etablissements Pierre Grehat Et Cie SA, Saint-Brice-Sous-Foret (FR)

(21) Appl. No.: 10/544,381

(22) PCT Filed: Jul. 6, 2005
(86) PCT No.: PCT/FR05/01742

§ 371 Date: Aug. 11, 2006

(51) Int. Cl. B26D 5/08

(52) U.S. Cl. 83/564; 83/523; 83/614

(57) ABSTRACT

A cutting tool for cutting a sheet of material has a base, a support attached to the base, and a blade pivotally mounted on the support for moving the blade between an open position for receiving a sheet of material to be cut between the support and the blade, and a closed position after a cutting operation. The support includes a sloth configured to receive the blade during cutting. The blade has a flat cutting edge with an arcuate profile. The tool also has a stop for retaining the sheet to be cut on the support during cutting.

The present invention relates to a cutting tool for cutting a sheet made of a reconstituted material.

Often used in the domain of modern construction are construction elements molded or reconstituted from materials present in the form of or reduced to the form of powder, fibers, granules or chips. Thus, as non-limiting examples, slabs of plaster, cement or ceramic as construction or finishing elements, siding sheets made of asbestos cement, sheets made of cellulose fibers of medium density as covering or finishing sheets, and laminated sheets as elements of a floating platform are used.

Because of the nature of the mixture of components from which the sheets are made or because of the use for which the sheets are made, they have two characteristics in common: the hardness of the sheet, or at least of its utilization side, and its thickness.

Each of these characteristics considered alone would not pose any particular problem in the case of cutting a sheet produced from one of the mentioned reconstituted materials. In effect, if one has a cutting tool whose cutting edge is harder than the element to be cut, the success of the cutting no longer depends on the force developed by the operator of the tool. Example: the cutting of ceramic slabs (therefore, tiling). And if one has a cutting tool which is capable of passing through the entire thickness of the element to be cut without remaining locked in it, cutting is possible. Example: the cutting of a conglomerate block work surface.

Since the sheets made of reconstituted material combine hardness and thickness, it is therefore necessary to have a tool which can overcome these two cutting difficulties.

But the tool under consideration must also meet another requirement: the tool must be simple to use and easy to stabilize on a ground surface, particularly on a more or less uneven ground surface, because the tool will be used mainly outside the workshop. Moreover, it would be useful for the tool not to be limited to right-angle cutting.

The objective of the invention is therefore to propose a cutting tool for cutting a sheet made of reconstituted material, which tool meets the various aforementioned requirements.

The objective of the invention is attained with a cutting tool for cutting a sheet made of reconstituted material, the tool having a base and a blade mounted so as to be mobile on a support attached to the base and allowing the blade to be moved between an open position for receiving a sheet made of reconstituted material to be cut between the support and the blade, and a closed position after a cutting operation.

According to the invention, the support is provided with a slot configured so as to receive the blade during cutting, the blade having a back and a flat and curved cutting edge, and the tool has a stop intended for retaining the sheet to be cut on the support during cutting.

Due to this design of the invention, the blade, in cooperation with the edges of the slot in the base, performs a double shearing, having the effect that, during cutting, the blade does not penetrate the material of the sheet to be cut in the usual manner, but rather removes a strip of material from the sheet. The width of the strip roughly corresponds to that of the blade. Thus, the sheet made of reconstituted material is not deformed, since it is supported on both sides of the blade by the two parts of the base situated on both sides of the slot in the base. Moreover, the sheet to be cut is retained on the base in such a way that it cannot escape in front of the descending blade. For this purpose, the tool has either a separate stop or a stop incorporated into the blade, as will emerge from the description of two embodiments of the invention.

The invention furthermore relates also to the following characteristics considered alone or according to any technically possible combination:
the cutting edge of the blade is obtained by laser cutting;
the curvature of the blade is determined so that in any actual position of the blade during cutting, the angle enclosed between the support and the blade is at least approximately constant;
the width of the slot is greater than the width of the blade;
the stop, if it is a separate element, has a large width;
the width of the stop corresponds in this case approximately to the length of the slot;
the stop is an element connected to the support, mounted perpendicularly to it;
the stop has an adjustable wedge making it possible to make variable-angle cuts;
the stop is a separate element mounted so as to be angularly variable on the support;
the stop has a mobile T-square allowing support of the reconstituted material to be cut;
the base is lengthened in the cutting direction by a foot ensuring stability of the tool in the cutting direction and in a direction transverse to this direction;
the blade is provided with a handle connected to the blade by an arm forming a lever;
the passage from the blade to the arm is configured so as to come to rest on the stop after cutting and thus to limit the course of travel of the blade towards its closed position;
the blade is provided with a handle which is offset from the back of the blade so that the handle is situated, after cutting, approximately at the same level as the slot or at a level lower than it.

Other characteristics and advantages of the present invention will emerge from the description hereafter of an embodiment of the tool according to the invention. The description refers to the appended drawings in which:

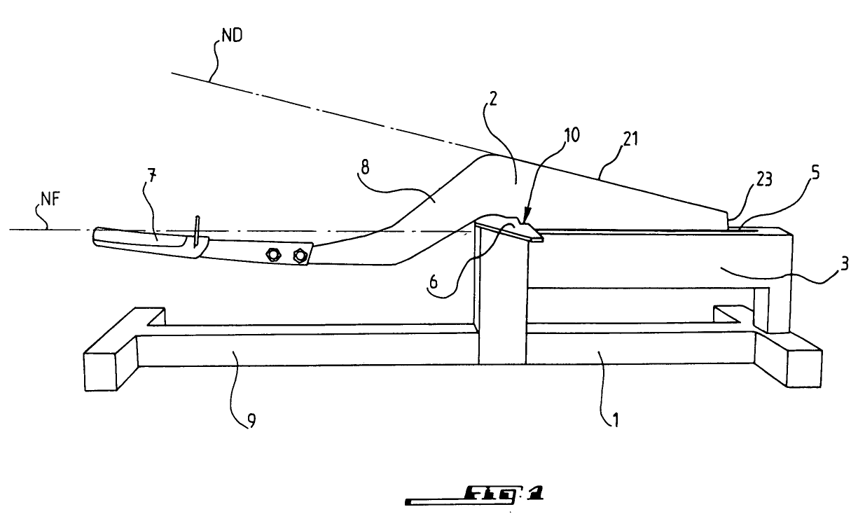

FIG. 1 shows a tool according, to a first embodiment of the invention, in closed position,

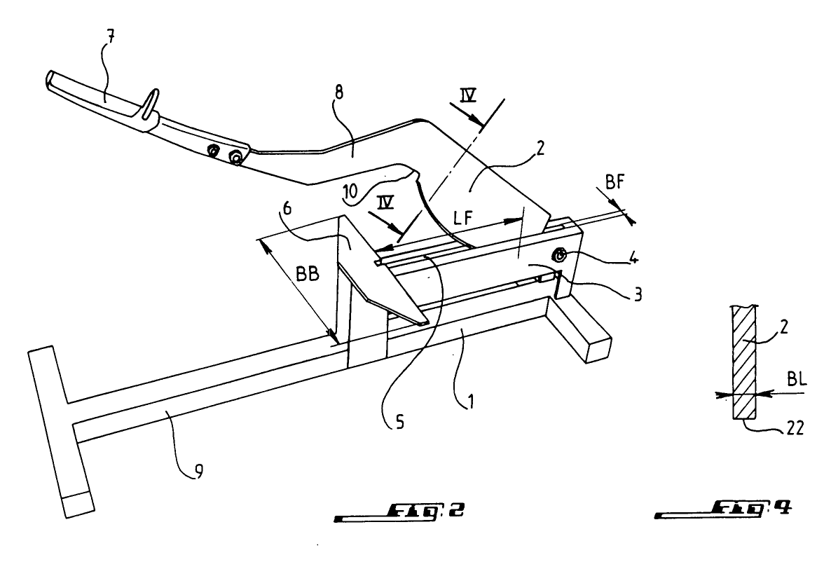

FIG. 2 shows the tool of FIG. 1 in half-open position,

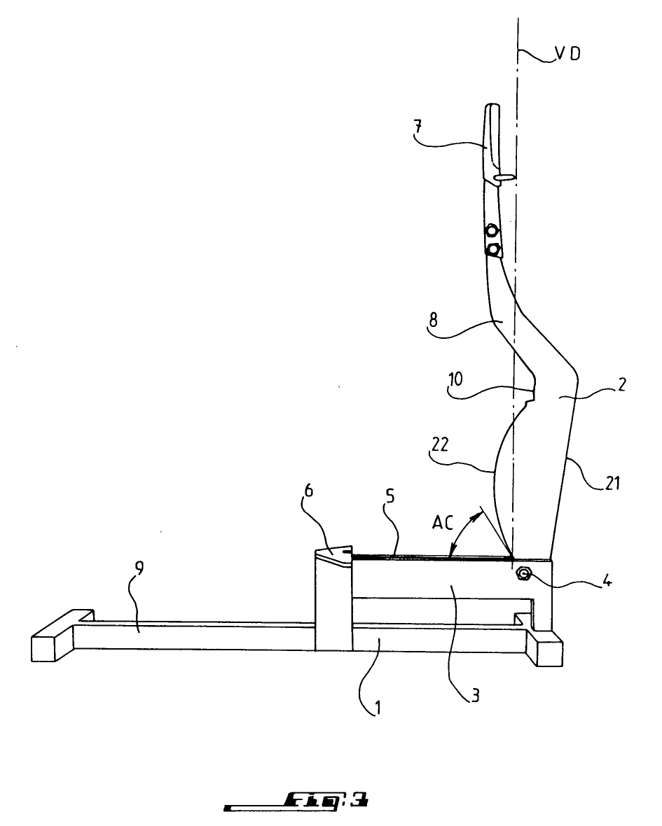

FIG. 3 shows the tool of FIG. 1 in open position,

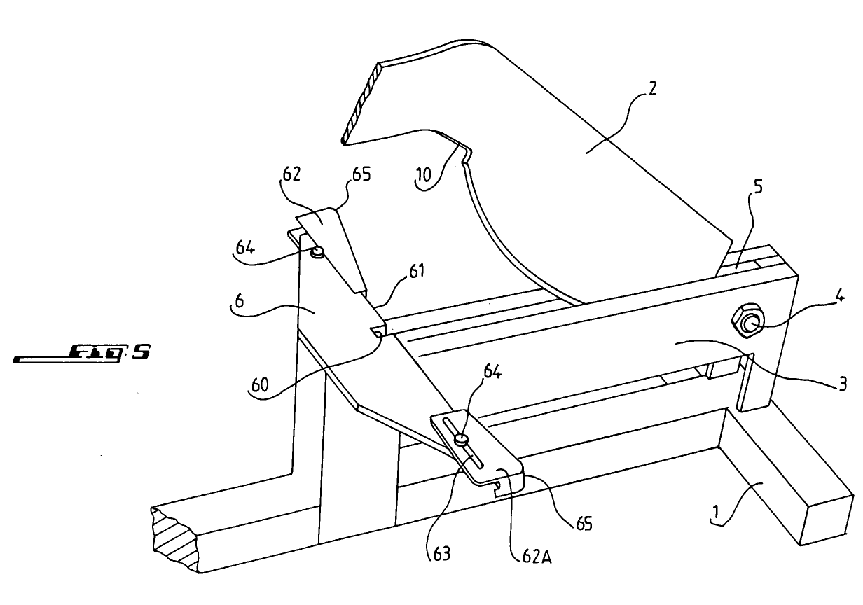

FIG. 4 shows the blade of the tool in cross section according to line IV-IV of FIG. 3,

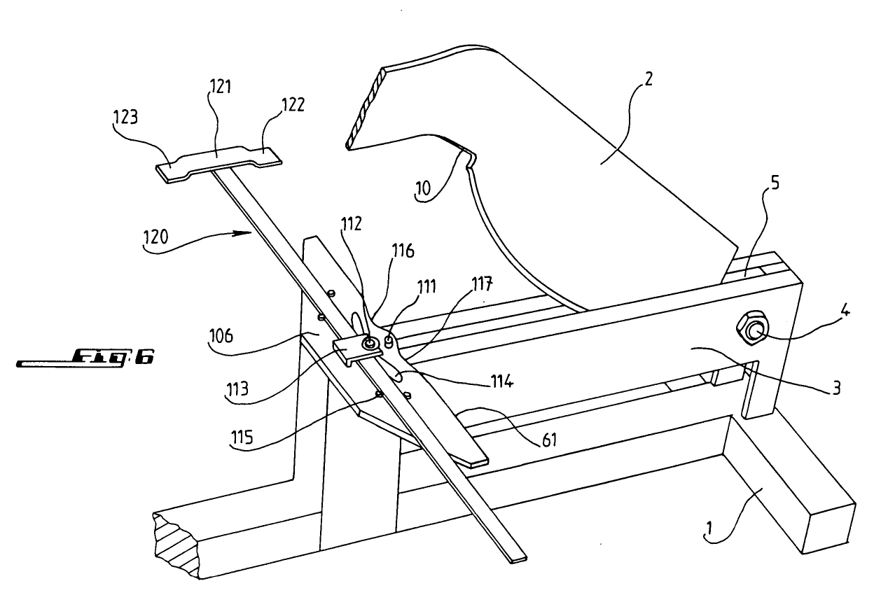

FIG. 5 shows the tool of FIG. 1 with a cutting accessory,

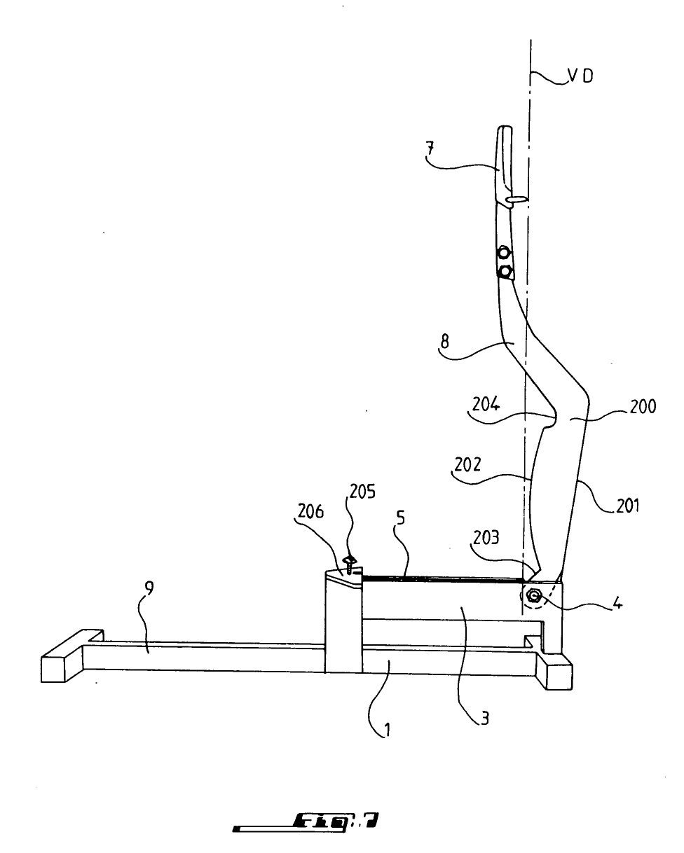

FIG. 6 shows a variant of the tool of FIG. 1, and

FIG. 7 shows a tool according to a second embodiment of the invention.

FIGS. 1 to 5 show a cutting tool according to a first embodiment of the invention for cutting a sheet made of a reconstituted material. The tool has base 1 and blade 2 mounted so as to be mobile on support 3 which is attached to base 1. Blade 2 is mounted so as to pivot around shaft 4, which enables blade 2 to be moved between an open position for receiving, between support 3 and blade 2, a sheet made of a reconstituted material to be cut, and a closed position after a cutting operation. During cutting, blade 2 encloses an angle AC with support 3.

Blade 2 is formed with back 21, flat and curved cutting edge 22 and stepped part 23. While the function of back 21 and of cutting edge 22 do not require any explanation, it is appropriate to specify that stepped part 23 makes it possible to limit the course of travel of blade 2 in the direction of the open position. The open position of blade 2 is reached when stepped part 23 comes to rest on support 3.

Support 3 is provided with slot 5 configured for receiving blade 2 during cutting, and with stop 6 intended for retaining the sheet to be cut during cutting. For the cutting operation, the sheet to be cut is placed on support 3 and made to rest against stop 6. Thus, during cutting, when blade 2 tends to drive the sheet to be cut in front of it because of a relatively large angle AC, and this, in addition to the actual cutting action, blade 2 keeps the sheet resting against stop 6.

So that stop 6 can succeed in the double task assigned to it, that is, preventing the sheet from being driven by blade 2 in the direction of cutting and maintaining the sheet in an angularly stable position so that a straight cut can be obtained, stop 6 must be wide. Advantageously, the width of stop 6 corresponds approximately to the length of slot 5 and preferably to the useful length of slot 5.

Cutting edge 22 of blade 2 was obtained by laser cutting. This way of producing blade 2 essentially provides two advantages. The first one is the possibility of obtaining in a single manufacturing step a clean cutting edge in any predetermined shape. This is all the more advantageous since cutting edge 22 is flat, as shown in FIG. 4, and therefore does not need to be sharpened.

In effect, according to the arrangements of the invention, blade 2 cooperates with slot 5 and more precisely with the longitudinal edges of the slot in the manner of a pair of scissor blades in parallel. Thus, each of the two longitudinal edges of cutting edge 22 of blade 2 forms, with the corresponding longitudinal edge of slot 5, a scissor part. The two scissor parts therefore, by simultaneous shearing during the descent of blade 2, progressively detaching the corresponding half of what is removed as the cutting progresses, such as a strip of the material of which the sheet to be cut is made.

Because of the thickness of the sheets to be cut and particularly to prevent blade 2 from being wedged into slot 5 by the material during cutting, the width BF of slot 5 is greater than the width BL of blade 2. The difference between width BF of slot 5 and width BL of blade 2 is determined as a function of the thickness of the sheets to be cut. As an example, in order to cut sheets with a thickness of approximately 7 mm, the difference between the two widths BF and BL is approximately 3 mm.

The curvature of blade 2 is determined in such a way that, in any actual position of the blade during cutting, the angle AC enclosed between support 3 and blade 2 is at least approximately constant.

Blade 2 is provided with handle 7 which is connected to blade 2 by arm 8 forming a lever. Passage 10 from blade 2 to arm 8 is configured so as to rest on stop 6 after cutting and thus to limit the course of travel of blade 2 in the direction of its closed position. The closed position of blade 2 is reached when passage 10 comes to rest on stop 6.

Handle 7 is offset from back 21 of blade 2 so that handle 7 after cutting is situated approximately at the same level as slot 5 or at a level lower than it. FIG. 1 represents this arrangement by means of broken lines ND and NF. Line ND is the extension of back 21 of blade 2, and line NF is the extension of slot 5. Handle 7 of blade 2 is offset from line ND and thus from back 21 of blade 2, by an angle sufficiently large to obtain the following two results.

The first result, already mentioned above, is represented in FIG. 1: after a cutting operation, handle 7 is situated at a lower level than that indicated by line NF, therefore lower than the level of slot 5. It goes without saying that the principle of this arrangement of the invention is also complied with when handle 7, after a cutting operation, is situated slightly above the level NF. This becomes obvious in looking at the second result obtained by this arrangement.

The second result, more important than the first but less easy to see, is represented in FIG. 3: at the beginning of a cutting operation, and preferably also when blade 2 is in open position, handle 7 is situated on the side of stop 6 to the vertical VD coming from a point marking the beginning of the cut on slot 5. It is expressly called “vertical” and not “perpendicular to slot 5,” because it is necessary to keep in mind that the tool of the invention is primarily intended for use outside the workshop. The ground surface or any other foundation on which the tool is placed will not necessarily be straight or horizontal everywhere. It is thus easy to imagine situations in which the tool is placed on a foundation which is resistant to the forces developed during cutting, but which cannot ensure a horizontal position for the tool. Consequently, in order to facilitate initiation of the cutting operation, it is recommended for handle 7 at the beginning of cutting to already be in a position that allows a person using the tool to use mainly his weight to move blade 2 instead of having to pull the blade towards him.

Furthermore, base 1 of the tool according to the invention is lengthened in the cutting direction by foot 9 ensuring the stability of the tool in the cutting direction and in the transverse direction to the cutting direction. In a simple form of execution, foot 9 is made up of a T-shaped structural bar as represented in FIGS. 1 to 3. An advantageous characteristic of foot 9, regardless of its shape, is that it allows the user of the tool to put his foot on foot 9 of the tool and to hold the tool throughout the cutting operation simply and safely while leaving his hands free for manipulation of blade 2.

FIG. 5 shows the tool according to the first embodiment of the invention, represented in FIGS. 1 to 4, with a cutting accessory. The cutting accessory entails wedge 62, configured so as to be attached on edge 61 of stop 6, edge 61 facing blade 2. Wedge 62 is furthermore represented twice, as, respectively, 62 and 62A in order to show that it is reversible.

In effect, during cutting of a floating platform or sheets of a floor or wall covering, angle irregularities are observed rather often. For example, the floor of a room is not truly rectangular. In such a case, it is a matter of being able to make the cuts with angles that differ so little from a right angle that it would be difficult to properly adjust an angularly adjustable stop as described later in reference to FIG. 6. Moreover, a suitable cutting operation of this type must be doable on one side as well as on the other side of the sheet.

In order to have a stable support allowing one to vary the cutting angle very finely, the invention proposes wedge 62, which is provided with oblong hole 63 for attaching onto stop 6 by bolt 64. Oblong hole 63 makes it possible to attach the wedge, such as wedge 62 or wedge 62A, onto one side or onto the other side, of stop 6, in different positions along edge 61 of stop 6. The sheet to be cut then rests on central notch 60 of stop 6 and on rounded corner 65 of wedge 62. It is easily understood that the closer wedge 62 is to notch 60, the more the cut will deviate from a right angle cut. The rounded shape of corner 65 of wedge 62 prevents ruining the edge of the sheet to be cut.

In order also to be able to use the tool of the invention for cuts with angles very different from a right angle, the tool is equipped, as a variant of stop 6 mounted stationary at a right angle to blade 2, with stop 106 mounted on support 3 so that it can be attached in different angular positions and different distances from shaft 4 of blade 2. To this effect, as represented in FIG. 6, stop 106 has guide rod 111 and bolt 112, both passing through stop 106 and projecting from it on both sides of the stop. Guide rod 111 is used for guiding stop 106 during its movements along slot 5. And bolt 112 is used for guiding stop 106, both during its movements along slot 5 and during adjustment of a cutting angle together with curved opening 114 made in stop 106.

Advantageously but not necessarily, stop 106 is equipped with ruler 120 mounted parallel to edge 61 of stop 106 facing blade 2. Ruler 120 is guided on stop 106 by pegs 115 projecting from the two sides of stop 106. Ruler 120 is attached to stop 106 by clamp 113, which itself is pressed onto the ruler and the stop by bolt 112.

The arrangement according to which guide rod 111, bolt 112 and pegs 115 project from the two sides of stop 106 enables one to use stop 106 on the top side or the reverse side. This is particularly advantageous when curved opening 114 is not symmetrical, so as to make possible a rather wide range of cutting angles without consequently weakening clamp 106 by too long an opening 114.

In order to ensure the best possible support for a sheet to be cut at an angle different from a right angle, stop 106, on its side 61, is provided with two notches 116, 117 also asymmetrical to one another.

Ruler 120 is advantageously but not necessarily produced in the form of a T-square, by integration of cross piece 121 having two opposite ends 122, 123. Depending on whether ruler 120 is oriented as shown in FIG. 6 or in the opposite direction, end 122 or end 123 is used as lateral stop and support for the reconstituted material to be cut.

FIG. 7 shows a tool according to a second embodiment of the invention. This second embodiment differs from the first essentially by a less-curved blade shape, referenced 200 in this case, which was determined so as to give blade 200 a different position of opening from the position of opening of blade 2 according to the first embodiment and so as to integrate stop 203 in blade 200. The characteristics of the second embodiment that are identical to those of the first embodiment bear the same reference numbers.

Blade 200 is formed with back 201, cutting edge 202, which is flat but less curved than that of blade 2, first stop 203 formed between cutting edge 202 and shaft 4 by which blade 200 is mounted on support 3, and second stop 204 formed between blade 200 and arm 8. While the functions of back 21 and of cutting edge 22 do not require any explanation, it is appropriate to specify the functions of the two stops 203 and 204.

Blade 200 can be formed with first stop 203 only or with first stop 203 and second stop 204 at the same time, according to the chosen execution variant of the second embodiment of the tool of the invention.

Blade 200 has the particular characteristic that the beginning of cutting edge 202 is spaced apart from support 3 and slot 5 of support 3 when blade 200 is in the open position. This is obtained by a distinct shape of the ends of the blade through which shaft 4 passes. This end is configured so as to also constitute the pivoting point of the blade, an element for raising the height of the blade to shaft 4 when the blade is in the open position and at the beginning of a cutting phase, and stop 203 against which a sheet to be cut is applied.

In effect, in a manner similar to the situation of blade 2 of the first embodiment, blade 200 drives the sheet to be cut by it, because of the angle enclosed by the blade with support 3. Since blade 200 encloses, with support 3, a much smaller angle than that enclosed by blade 2, and since this angle at the beginning of cutting is turned towards shaft 4, the vertical component of the pressure exerted by blade 200 is, from the beginning of cutting, sufficiently high to immobilize the sheet. Possibly, particularly when the sheet is less thick than that which corresponds to the height of stop 203, the blade has rather a tendency to drive the sheet towards shaft 4. It is therefore unnecessary to provide stop 206 on support 3.

In contrast, when sheets are to be cut at an angle different from a right angle, stop 203 of blade 200 cannot ensure precise positioning of the sheet. It is therefore necessary to use stop 206 mounted so as to be mobile by means of bolt 205, this stop corresponding essentially to stop 106 of the first embodiment. In order not to reduce the course of travel of blade 200 by projecting bolt 205, blade 200 has notch 204, which also forms a stop that rests on bolt 205 when blade 200 has reached the closed position.

1. A cutting tool for cutting a sheet of a material, comprising:
a base
a support attached to the base and including a slot; and
a blade pivotally mounted on the support for movement between an open position for receiving a sheet of a material to be cut between the support and the blade, and a closed position, after a cutting operation, wherein
the slot receives the blade during cutting,
the blade has a back and a flat cutting edge with an arcuate profile, and
the support includes a stop for retaining the sheet to be cut on the support during cutting.

2. The tool according to claim 1, wherein the cutting edge of the blade is formed by laser cutting.

3. The tool according to claim 1, wherein the arcuate profile of the blade is shaped so that, at any position during cutting, an angle enclosed between the support and the blade is at least approximately constant.

4. The tool according to claim 1, wherein the slot and the blade have respective widths and the width of the slots is larger than the width of the blade.

5. The tool according to claim 1, wherein the stop is a separate element mounted on the support.

6. The tool according to claim 1, wherein the stop is integrated with the blade.

7. The tool according to claim 5, wherein the stop is an element connected to the support and mounted perpendicular to the support.

8. The tool according to claim 5, wherein the stop has an adjustable wedge for making variable-angle cuts.

9. The tool according to claim 5, wherein the stop is a separate element that is angularly variable on the support.

10. The tool according to claim 9, wherein the stop includes a T-square for supporting the sheet of material to be cut.

11. The tool according to claim 1, wherein the base includes, extending in a cutting direction, a foot stabilizing the tool in a cutting direction and in a direction transverse to the cutting direction.

12. The tool according to claim 1, wherein the blade include an arm and a handle connected to blade by arm forming a lever.

13. The tool according to claim 12, wherein blade and the arm are configured to rest on the stop after a cutting operation, limiting travel of the blade towards the closed position.

14. The tool according to claim 1, wherein the blade includes a handle offset from the back of the blade so that the handle is situated, after a cutting operation, approximately coplanar with the slot or below the slot.
